(19) United States
(12) Patent Application Publication
(10) Pub. No.: US 2026/0115769 A1
(43) Pub. Date: Apr. 30, 2026

(54) Portable gutter and downspout cleaning device

(71) Applicant: Liheng Liu, Portland, OR (US)

(72) Inventor: Liheng Liu, Portland, OR (US)

(21) Appl. No.: 18/927,094

(22) Filed: Oct. 25, 2024

(51) Int. Cl. B08B 5/02; B08B 9/032; E04D 13/076

(52) U.S. Cl. CPC B08B 5/02; B08B 9/0328; E04D 13/0765; B08B 2209/032

(57) ABSTRACT

The present invention introduces a portable gutter and downspout cleaning device for use with leaf blowers, featuring a blower nozzle with a rotatable elbow, flat plastic tubing, and a gutter cleaning nozzle with an extension pole socket. The tubing length is customizable for various gutter heights and accessibilities, and fastening components ensure airtight connections between the tubing and nozzles, transforming the tubing into an extended air conduit. For downspout cleaning, air pressure from the blower inflates the tubing within the downspout, using the downspout as an extended air conduit to facilitate debris removal. The rotatable connection incorporates tiered outer teeth and internal grooves with cross-channels, enabling secure assembly and rotational movement. A locking mechanism restricts the teeth from passing through the cross-channels, preventing unintended disconnection. This invention offers a cost-effective, adaptable solution for cleaning both gutters and downspouts safely from ground level, significantly reducing the risks associated with ladder-related injuries.

### BACKGROUND OF THE INVENTION

The present invention relates to a portable gutter and downspout cleaning device that allows users to clean overhead gutters and downspouts from ground level. More specifically, the invention utilizes airflow generated by a leaf blower to remove debris from gutters and downspouts.

The present invention relates to a portable gutter and downspout cleaning device that allows users to clean overhead gutters and downspouts from ground level. More specifically, the invention utilizes airflow generated by a leaf blower to remove debris from gutters and downspouts.

Traditionally, gutter cleaning involves using ladders or climbing onto rooftops, which poses significant safety risks. According to the Centers for Disease Control and Prevention (CDC) in the United States, hundreds of people die annually from ladder-related injuries, and over 500,000 individuals are treated for such injuries each year, as reported by the Consumer Product Safety Commission.

Property owners and gutter cleaning service providers face challenges related to ladder-related injury risks, hiring costs, and potential insurance and liability issues. Consequently, there has been a long-standing need for gutter and downspout cleaning devices that allow users to remain on the ground while efficiently removing debris from overhead gutters and downspouts.

To address this need, various gutter cleaning tools and devices have been developed. These range from hand tools mounted on extension poles, such as scoops, clamps, and rakes, to methods using vacuum hose nozzles, water flow, fans, or air blowers. Additionally, some approaches involve connecting solid extension pipes to leaf blowers to function as extended blower nozzles. Despite these developments, the lack of efficient tools has led some companies to develop and market gutter cleaning robots. However, these approaches have limitations, as they still require users to climb ladders to place and retrieve the robot. Furthermore, rain gutters, downspouts, and drain pipes all require regular maintenance to ensure proper drainage. If gutters can be cleaned from the ground level, but downspouts cannot, homeowners or gutter cleaning service providers may still need to climb ladders to clean or unclog downspouts.

For most gutter systems, multiple gutter hangers are installed perpendicularly along the upper edge to provide structural support. These hangers can create significant obstacles for gutter cleaning tools that require physical contact with the gutter surface, such as scoops, brushes, or other attachments mounted on extension poles. When these tools encounter gutter hangers, their continuous movement along the gutter line is disrupted, limiting their ability to clean debris effectively. This interference not only reduces the mobility and efficiency of the cleaning device but also forces users to exert more effort to maneuver the tool around each hanger. Moreover, repeated physical contact between the tool and the gutter surface can cause wear and tear, potentially damaging the gutter's paint or loosening the hangers. Such damage may lead to costly repairs, including repainting the gutters or reattaching hangers. Tasks like these often require climbing ladders, introducing additional risks of ladder-related injuries.

Gutter cleaning devices requiring the manual operation of lengthy extension poles, extended water wands, rigid air tubes, or PVC pipes pose significant challenges due to weight and torque. In accordance with the lever principle, which states that “torque equals force multiplied by the lever arm,” even a small increase in weight, particularly at the distal end of the tool, can substantially increase the torque exerted on the user's hands. Furthermore, when the length of the pole, wand, air tube, or pipe remains constant, decreasing the angle between the long tool and the ground lengthens the lever arm, thereby increasing the torque. This indicates that the accessibility of the gutters significantly impacts the physical effort required: if the user is unable to position themselves close to the siding below the gutter, the torque exerted on the arms is notably higher. Consequently, both a lightweight design and the ability to provide users with flexible options for various access scenarios are essential for reducing user fatigue.

For those gutter cleaning devices utilizing rigid air tubes connected to leaf blowers, functioning as extended blower nozzles (as disclosed in U.S. Pat. No. 8,739,362 B1, “GUTTER CLEANING ATTACHMENT FOR A LEAF BLOWER,” and US Patent Application 2015/0107050 A1, “GUTTER CLEANING ATTACHMENT FOR LEAF BLOWERS”), achieving a critical balance between weight, length, and tube rigidity is essential. In general, when the material and dimensions remain constant, increased rigidity necessitates a thicker and heavier air tube. Conversely, reducing the tube's weight may compromise its structural integrity, rendering it insufficient for effectively cleaning gutters located on second-story or higher elevations. Due to airflow requirements, these long, rigid air tubes are typically designed with diameters significantly larger than extension poles, which complicates manual handling and operation.

In prior art, a blowing nozzle mounted on an extension pole and connected to an air blower using a soft air tube (as illustrated by the design disclosed in U.S. Design Pat. No. D877,346 S, “GUTTER CLEANING DEVICE”) presents several operational challenges. The addition of a scoop to the gutter blowing nozzle increases the weight at the top of the extension pole, thereby increasing the torque and making the device more difficult to maneuver. Additionally, the presence of multiple gutter hangers along the gutter line restricts the scoop's ability to move continuously, further complicating the cleaning process. Although the use of a soft air tube reduces weight compared to rigid air tubes, its pliability makes it susceptible to twisting and folding, which can obstruct airflow. This issue is exacerbated by the design of leaf blower nozzles, which are generally intended to operate in a relatively horizontal orientation toward the ground, whether used as handheld or backpack models. As a result, they are not designed to point upwards and align freely with the pole. This misalignment can cause the soft air tube to twist and fold, leading to airflow blockages at the connection point between the soft tube and the leaf blower nozzle.

Additionally, gutter heights can vary significantly across different buildings. Even within the same house, gutters may be installed at varying heights. Furthermore, using an excessively long soft air tube with a shorter extension pole can result in airflow obstruction. Consequently, there is no standardized tube length that is suitable for all situations, presenting an unresolved problem in existing solutions.

Accordingly, there is a significant demand for portable gutter and downspout cleaning devices that allow users to stand on the ground while effectively cleaning gutters and downspouts at various heights and levels of accessibility. The present invention seeks to provide a lightweight, portable, and customizable solution that enables users to safely clean both gutters and downspouts from the ground, thereby significantly reducing the risks of ladder-related body injury.

### SUMMARY OF THE INVENTION

The present invention relates to a portable gutter and downspout cleaning device designed for use with leaf blowers. The device comprises a blower nozzle equipped with a rotatable elbow, flat plastic tubing, and a gutter cleaning nozzle featuring an extension pole socket. Fastening components, such as reusable zip ties, are used to create airtight connections between the flat plastic tubing and both the blower nozzle and the gutter cleaning nozzle. This configuration effectively transforms the flat plastic tubing into an extended air conduit for the leaf blower, allowing users to clean overhead gutters from ground level by utilizing the airflow generated by the blower.

The rotatable elbow on the blower nozzle allows the air outlet direction to be adjusted to align with the extension pole and the flat plastic tubing, thereby preventing the tubing from twisting or folding and ensuring unobstructed airflow. The lightweight nature of the flat plastic tubing reduces physical strain on the user, while its smooth interior surface minimizes air pressure loss. Additionally, the low cost of the flat plastic tubing enables users to cut and customize the tubing length to accommodate different gutter heights and accessibilities, thereby improving operational performance and ease of storage.

For downspout cleaning, the invention requires that the downspout have an accessible opening at ground level, such as one equipped with a downspout leaf filter. The user can insert one end of the flat plastic tubing into the downspout and connect the other end to the blower nozzle's rotatable elbow. The airflow from the leaf blower causes the flat plastic tubing to expand within the downspout and maintain an extended shape, thereby creating an airtight connection with the interior of a downspout, facilitating the removal of debris from the downspout through the airflow directed via the tubing. The rotatable elbow accommodates flat plastic tubing of various diameters to fit downspouts with different cross-sectional sizes and shapes, while allowing for adjustable airflow direction to facilitate cleaning in narrow or confined spaces.

The present invention offers a cost-effective and customizable solution for cleaning both gutters and downspouts from ground level, enabling users to customize air tubing lengths to accommodate different gutter heights and levels of accessibility. This approach significantly reduces the risks associated with ladder-related injuries. Additionally, using compostable flat plastic tubing promotes environmentally sustainable practices

### BRIEF DESCRIPTION OF DRAWINGS Various embodiments of the invention are disclosed in the following detailed description and accompanying drawings.

FIG. 1 is a perspective view of one embodiment of a portable gutter and downspout cleaning device of the present invention, illustrating the device in a disassembled configuration.

FIG. 2 is a perspective view of the device shown in FIG. 1, illustrating the disassembled configuration with an associated leaf blower and an extension pole.

FIG. 3 is a perspective view of the device shown in FIG. 1, illustrating the manner in which the gutter and downspout cleaning device of the present invention is used to clean an overhead gutter.

FIG. 4 is a perspective view of the device shown in FIG. 1, illustrating the manner in which the gutter and downspout cleaning device is used to clean a downspout.

FIG. 5 is a perspective view of the blower nozzle of the device shown in FIG. 1, illustrating the blower nozzle with a rotatable elbow in a disassembled configuration.

FIG. 6 is a perspective view of the blower nozzle of the device shown in FIG. 1, illustrating the blower nozzle with a rotatable elbow in an assembled configuration.

FIG. 7 is a side view of the blower nozzle of the device shown in FIG. 1, illustrating the connection between the rotatable elbow and the blower nozzle base in a disassembled configuration.

FIG. 8 is a perspective view of the connection portion of the blower nozzle of the device shown in FIG. 1, illustrating the rotatable connection between the rotatable elbow and the blower nozzle base in a disassembled configuration.

FIG. 9 is another perspective view of the connection portion of the blower nozzle of the device shown in FIG. 1, illustrating the rotatable connection between the rotatable elbow and the blower nozzle base in a disassembled configuration.

FIG. 10 is a top view of the connection portion of the blower nozzle of the device shown in FIG. 1, illustrating the rotatable connection between the rotatable elbow and the blower nozzle base in a disassembled configuration.

FIG. 11 is a section view of the blower nozzle of the device shown in FIG. 1, illustrating the connection between the rotatable elbow and the blower nozzle base in an assembled configuration

FIG. 12 is a perspective view of the gutter cleaning nozzle of the device shown in FIG. 1.

FIG. 13 is a side view of the gutter cleaning nozzle of the device shown in FIG. 1.

FIG. 14 is a section view of the gutter cleaning nozzle of the device shown in FIG. 1.

FIG. 15 is a perspective view of an alternative embodiment of the blower nozzle of the present invention, illustrating the blower nozzle with a rotatable elbow in a disassembled configuration.

FIG. 16 is a side view of the blower nozzle shown in FIG. 15, illustrating the rotatable connection between the rotatable elbow and the blower nozzle base in a disassembled configuration.

FIG. 17 is a perspective view of the connection portion of the blower nozzle shown in FIG. 15, illustrating the rotatable connection between the rotatable elbow and the blower nozzle base in a disassembled configuration.

FIG. 18 is another perspective view of the connection portion of the blower nozzle shown in FIG. 15, illustrating the rotatable connection between the rotatable elbow and the blower nozzle base in a disassembled configuration.

FIG. 19 is a top view of the connection portion of the blower nozzle shown in FIG. 15, illustrating the rotatable connection between the rotatable elbow and the blower nozzle base in a disassembled configuration.

FIG. 20 is a section view of the blower nozzle shown in FIG. 15, illustrating the rotatable connection between the rotatable elbow and the blower nozzle base in an assembled configuration.

### DETAILED DESCRIPTION OF THE INVENTION

Before describing the present invention in detail, it should be noted that the terminology used herein is for the purpose of describing exemplary embodiments only. The disclosed embodiments are illustrative and not restrictive. As used in this specification and the accompanying claims, terms in the singular forms such as “a,” “an,” and “the” include their plural referents unless the context clearly indicates otherwise. The scope of the invention encompasses numerous alternatives, modifications, and equivalents; it is limited only by the claims.

The specific details provided herein are set forth in the following description to provide a thorough understanding of the invention. However, the invention may be practiced according to the claims without incorporating all of these specific details. For clarity, technical material known in the relevant technical fields has not been described in detail, so as not to unnecessarily obscure the invention.

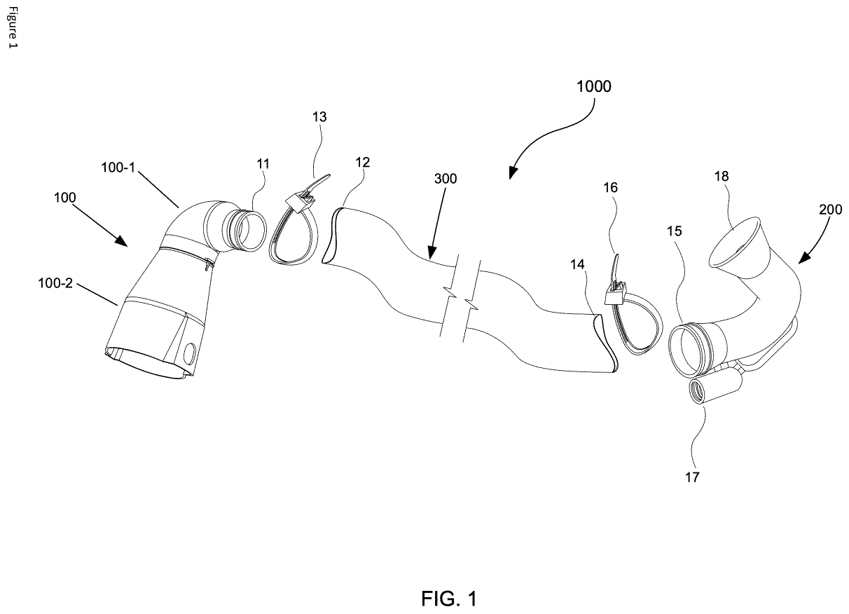

Referring now to a preferred embodiment of the present invention, as illustrated in FIG. 1, a portable gutter and downspout cleaning device 1000 is disclosed. The device comprises a blower nozzle 100 equipped with a rotatable elbow 100-1, a gutter cleaning nozzle 200 that includes an extension pole socket 17, and flat plastic tubing 300.

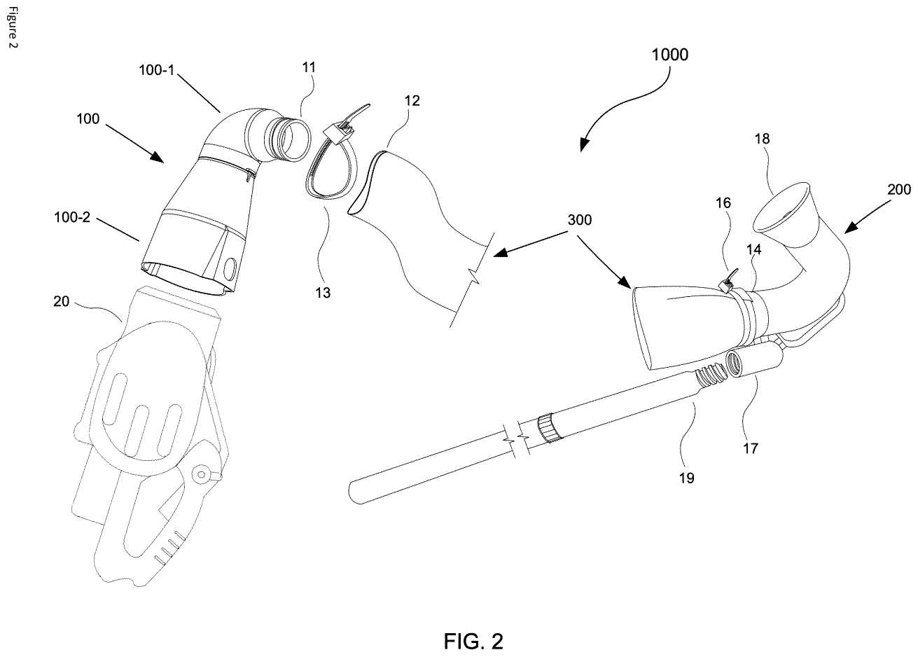

With reference to FIGS. 2, 3 and 5, the blower nozzle 100 comprises a rotatable elbow 100-1 and a blower nozzle base 100-2, configured to connect to a leaf blower 20. One end 12 of the flat plastic tubing 300 is airtightly secured to the external surface of the elbow air outlet 11 using a reusable plastic zip tie 13. The opposite end 14 of the flat plastic tubing 300 is connected to the air inlet 15 of the gutter cleaning nozzle 200 and secured in a similar manner with a reusable plastic zip tie 16. This arrangement transforms the flat plastic tubing 300 into an extended air conduit for the leaf blower 20, allowing users to clean overhead gutters 21 from ground level by utilizing the airflow generated by the leaf blower 20. The rotatable elbow 100-1 enables the direction of the air outlet 11 to be adjusted to align with the extension pole 19 and flat plastic tubing 300, ensuring the tubing remains untwisted and unobstructed during use. The smooth internal surface of flat plastic tubing 300 reduces air pressure loss, while its lightweight construction minimizes user fatigue. Additionally, the cost-effectiveness of the flat plastic tubing 300 allows users to cut and customize its length to accommodate different gutter heights and accessibilities, enhancing operational performance and storage efficiency.

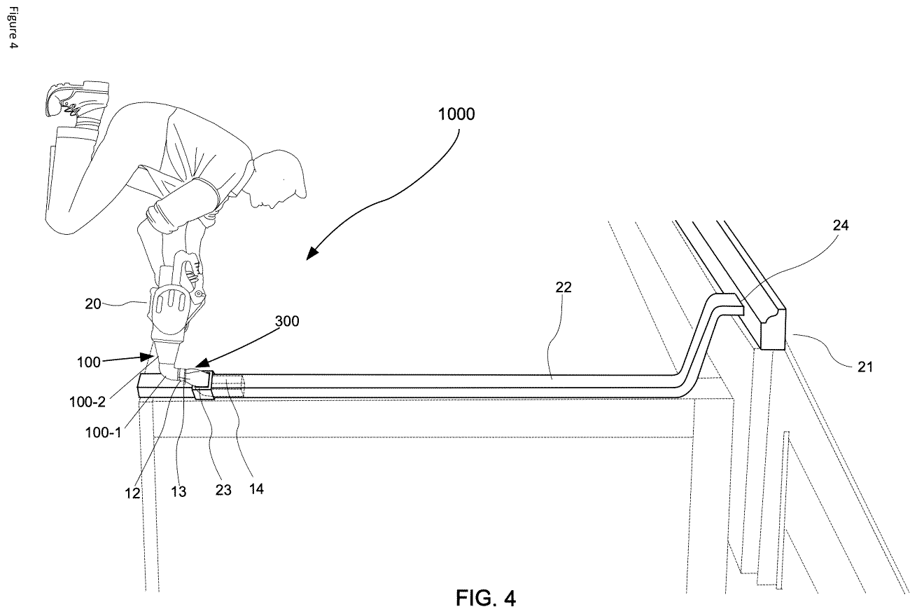

In further detail, as illustrated in FIG. 4, the use of the gutter and downspout cleaning device 1000 to clean a downspout 22 from ground level is depicted. The downspout 22 includes a leaf filter 23, which provides open access at ground level. In this configuration, the user connects one end 12 of the flat plastic tubing 300 to the rotatable elbow 100-1 of the blower nozzle 100, inserts the opposite end 14 of the flat plastic tubing 300 upward into the downspout 22, and uses the airflow generated by the leaf blower 20 to perform the cleaning. The perimeter of the flat plastic tubing 300's cross-section is larger than the interior perimeter of the downspout 22, allowing the flexible tubing to be inflated and form a temporary airtight contact against the downspout's interior surfaces when air pressure is applied. This airtight contact facilitates the upward airflow needed to dislodge and blow debris out of the downspout 22 through the gutter drop outlet 24. The rotatable elbow 100-1 is compatible with flat plastic tubing 300 of various diameters, accommodating downspouts of different sizes and shapes. It also enables easy adjustment of airflow direction, improving access to tight or narrow spaces and offering multiple positioning angles for positioning the leaf blower 20.

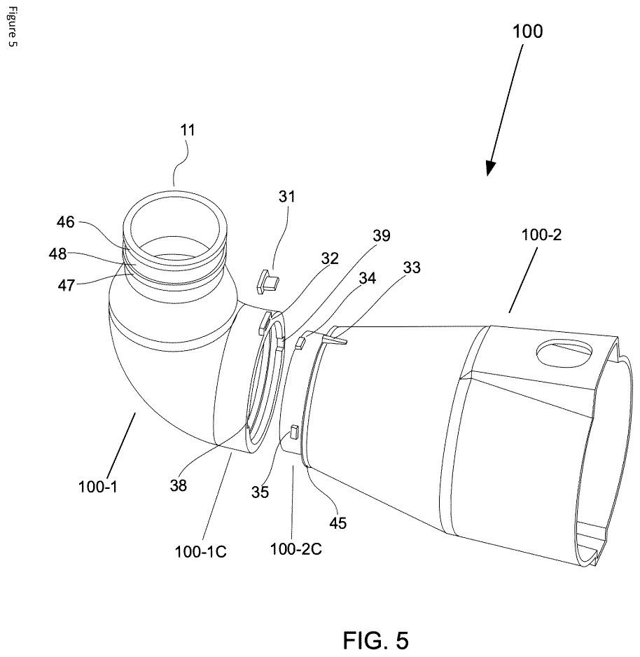

Referring now to FIG. 5, an embodiment of the blower nozzle 100 with a rotatable elbow 100-1 is shown in detail. The rotatable elbow 100-1 is a 90-degree elbow that redirects airflow. The air outlet 11 of the elbow includes a groove 48 designed to secure the reusable zip tie 13, as shown in FIG. 2. The two walls 46 and 47 of the groove 48 assist in securing the reusable zip tie 13, enhancing the airtight connection between the flat plastic tubing 300 and the air outlet 11. In this embodiment, the connection between the rotatable elbow 100-1 and the blower nozzle base 100-2 is a quick-connect, rotatable tube connection utilizing tiered outer teeth and tiered internal annular grooves with cross-channels. The details of this connection are disclosed in a separate patent application, “Tube Connection and its Mechanism” (U.S. Pat. No. 18/596,675), filed on Mar. 6, 2024. In brief, this tube connection, described in U.S. Pat. No. 18/596,675, introduces a quick-connect, rotatable tube connection applicable to a variety of uses. The connection comprises a male connector with tiered outer teeth and a female connector with tiered internal annular grooves, designed to engage the teeth and allow movement within the grooves. Each groove features cross-channels on its walls, allowing the teeth to pass through and enter adjacent annular grooves. Through relative coaxial rotation, the alignment of the teeth and cross-channels can either be established or interrupted, allowing the connectors to be engaged or disengaged via axial movement. The tube connection described in U.S. Pat. No. 18/596,675 also enables the inclusion of a locking mechanism with corresponding elements on both connectors, which limits their relative rotational movement and prevents disengagement of the tube connection by blocking the alignment of the teeth and cross-channels, while still allowing limited rotational movement of the rotatable connection.

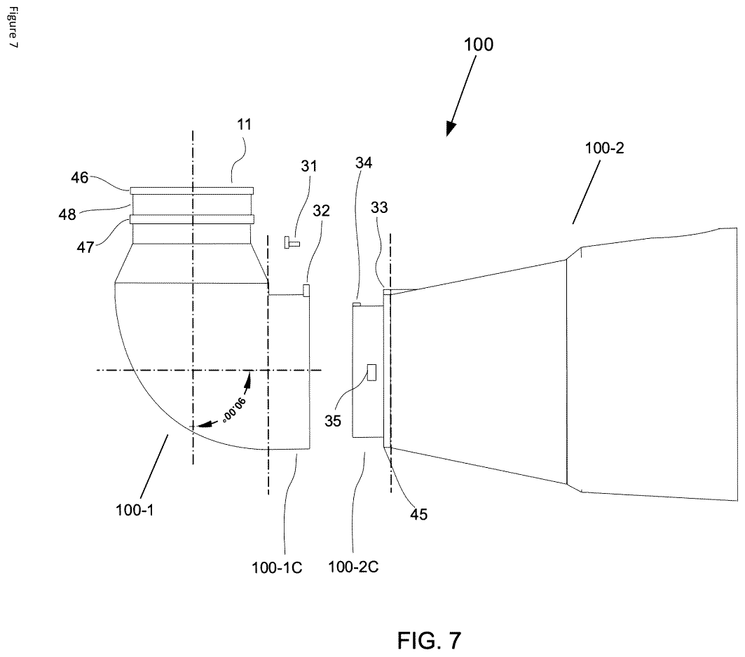

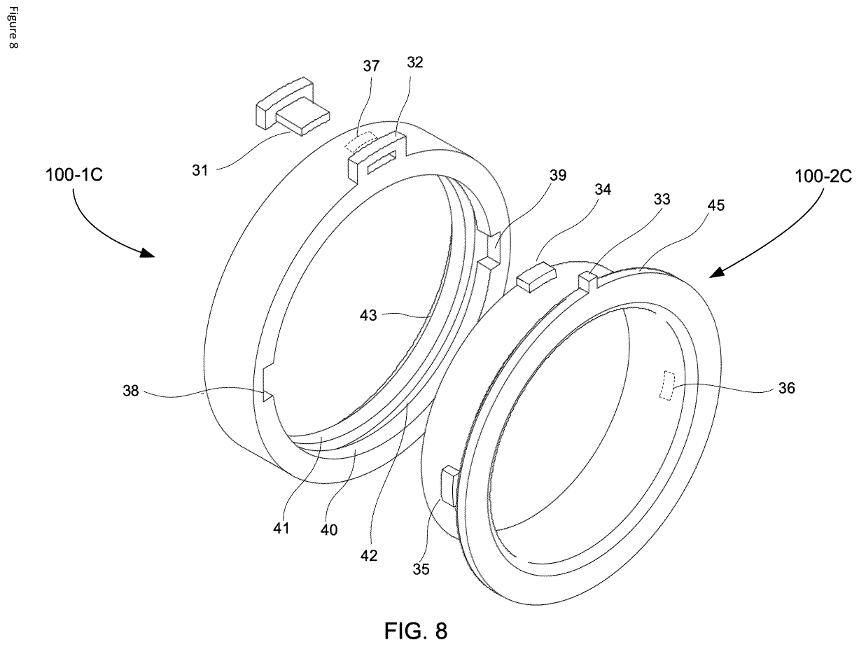

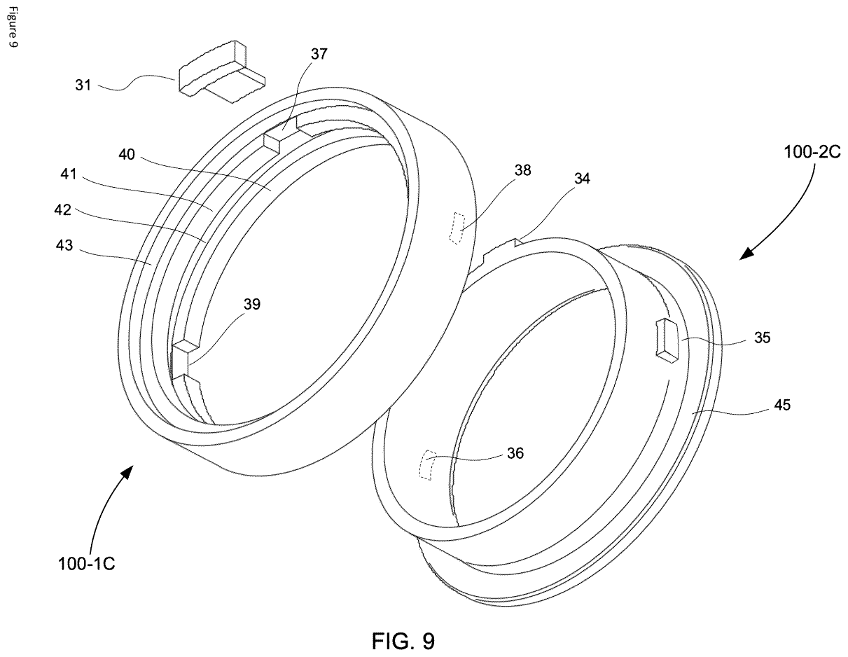

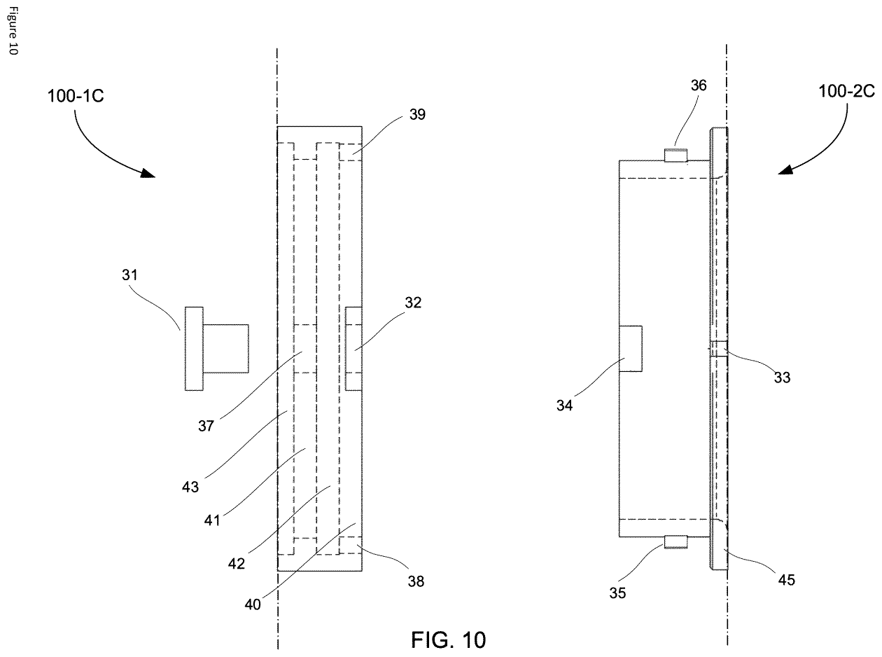

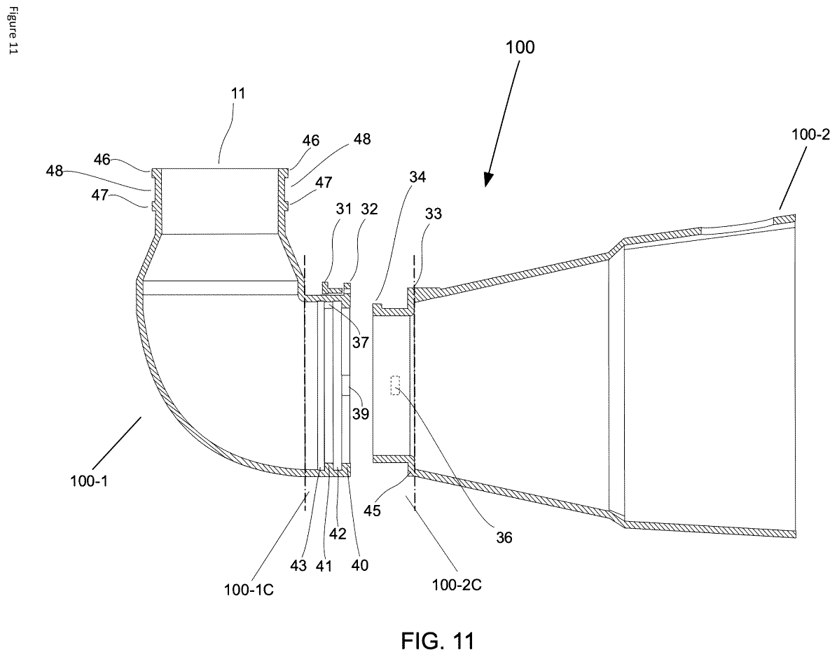

More specifically, in an exemplary embodiment of the connection for the blower nozzle 100 of the present invention, as shown in FIGS. 5-11, the tube connection comprises a male connector 100-2C with tiered outer teeth 34-36 and a female connector 100-1C with tiered internal annular grooves 42-43. The grooves are configured to accommodate the teeth 34-36, allowing them to move within the grooves 42-43. Each groove includes a groove wall, 41 or 42, which features cross-channels 37-39 that enable the teeth 34-36 to pass through and enter adjacent annular grooves. By means of relative coaxial rotation, the alignment between the teeth 34-36 and the cross-channels 37-39 can either be established or interrupted. Through axial movement, such as pushing or pulling, the connectors, 100-1C and 100-2C, can engage or disengage. In this embodiment, a locking mechanism is incorporated, featuring corresponding elements 31-33 on both connectors. This mechanism restricts relative rotational movement and prevents disengagement of the connection by blocking the alignment of the teeth 34-36 with the cross-channels 37-39.

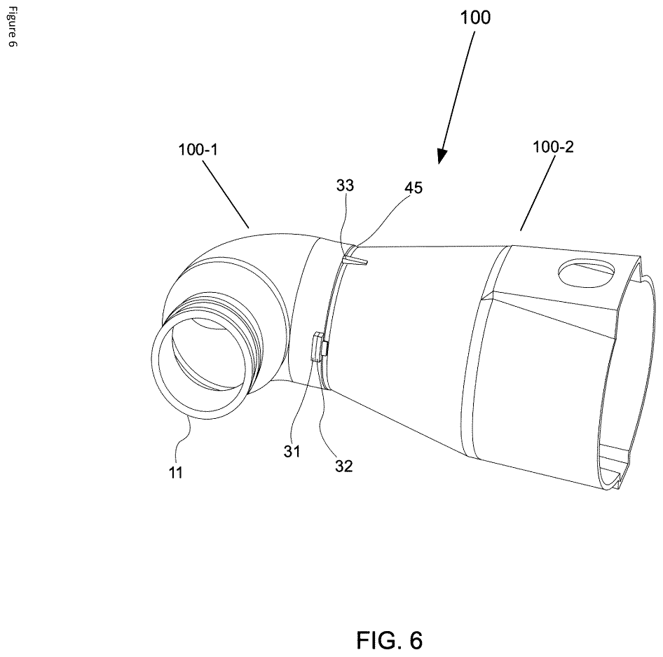

Referring to FIGS. 5 and 6 in detail, once the locking latch 31 is inserted into the latch receiver 32, the latch stopper 33 obstructs the rotational path by coming into contact with the locking latch 31. This obstruction prevents tooth 34 from aligning with cross-channel 37, and similarly, teeth 35 and 36 from aligning with cross-channels 38 and 39, respectively.

Referring to FIGS. 2, 5, 6, 7, and 11, the blower nozzle base 100-2 in this embodiment is specifically configured to connect to a particular model of leaf blower 20. Given the wide variety of leaf blower models available on the market, which differ in dimensions, sizes, shapes, and specifications, the blower nozzle base 100-2 can be reconfigured as needed. While the connection portion 100-2C may remain uniform across different blower models, the rest of the blower nozzle base 100-2 can be produced in various dimensions, sizes, and shapes to accommodate current and future leaf blower models.

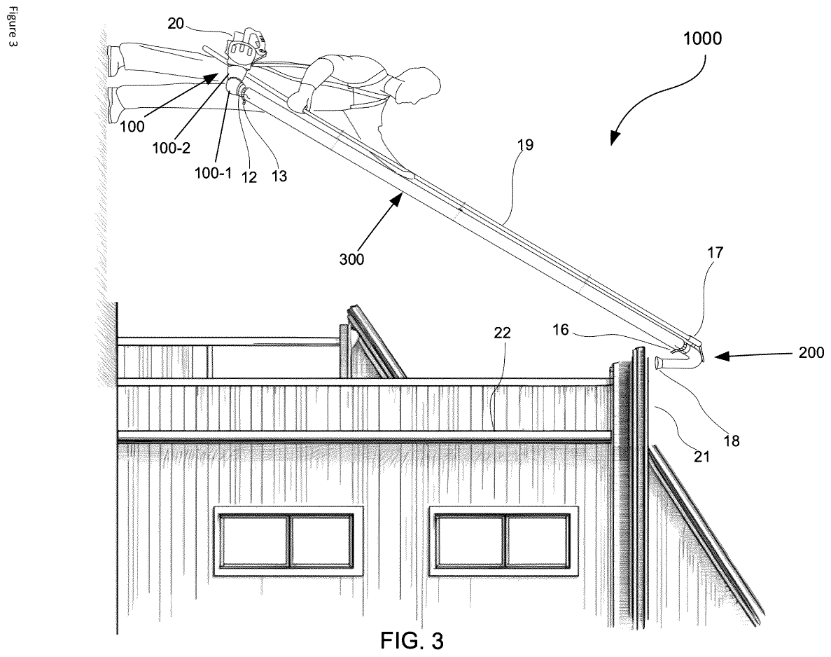

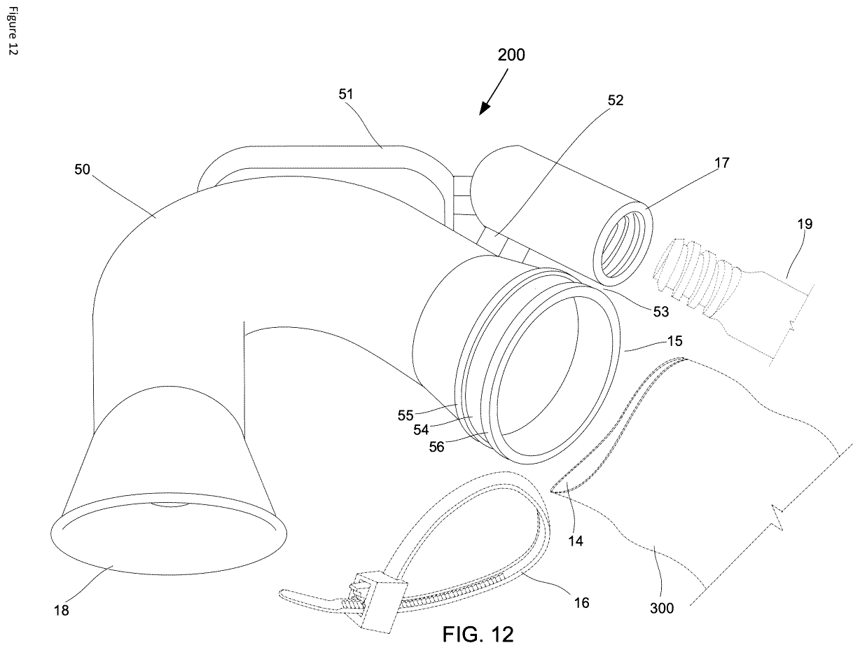

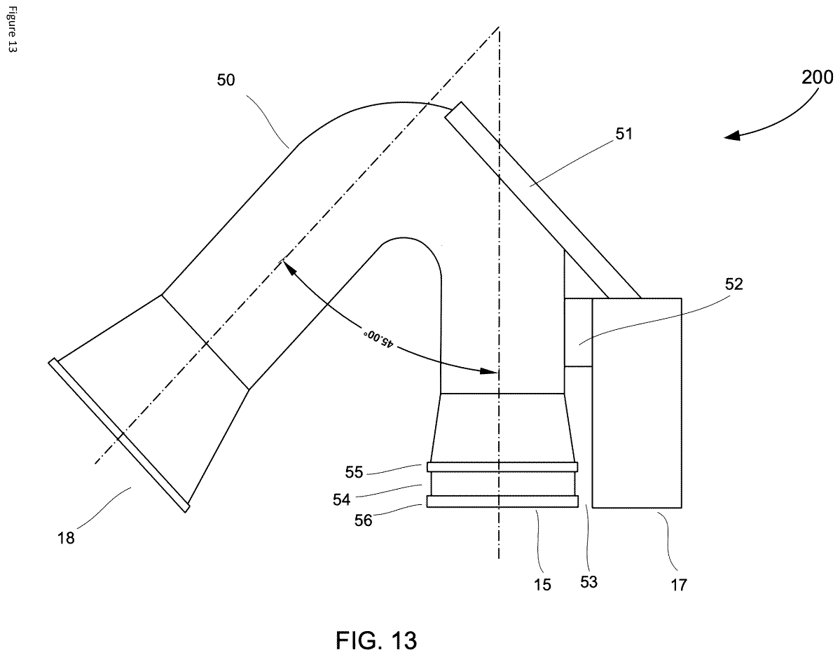

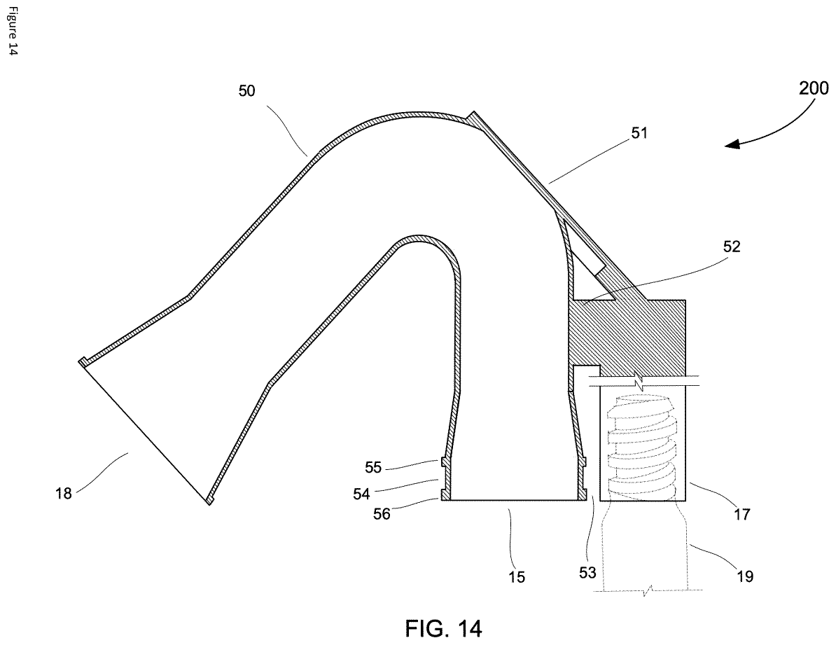

Referring now to FIGS. 12-14, the gutter cleaning nozzle 200 of FIG. 1 includes a gutter cleaning nozzle body 50 and an extension pole socket 17, featuring two connection portions, 51 and 52, that provide solid integration and form a lead space 53 between the extension pole socket 17 and the gutter cleaning nozzle air inlet 15. This lead space 53 allows the end 14 of the flat plastic tubing 300 to be connected over the air inlet 15 and secured with a reusable zip tie 16. Through the extension pole socket 17, the gutter cleaning nozzle 200 may be attached to an extension pole 19. The nozzle body 50 forms a 45-degree elbow, directing airflow from the air inlet 15 to the air outlet 18. The air inlet 15 includes a groove 54 designed to accommodate the zip tie 16, and groove walls 55 and 56 enhance the airtight connection by securely holding the zip tie 16, ensuring a stable connection between the flat plastic tubing 300 and the air inlet 15. FIGS. 2 and 3 illustrate the connection of the gutter cleaning nozzle 200 to the flat plastic tubing 300.

While various details of an embodiment of the present invention have been described above, it should be understood that other embodiments of the present invention are possible. For instance, the elbow angle of the gutter cleaning nozzle body 50 can differ from 45 degrees, and the rotatable elbow's angle can vary from 90 degrees. In present invention, the rotatable connection of the rotatable elbow relies on tiered outer teeth and tiered internal annular grooves with cross-channels. The specific details may vary depending on the application. For example, the number of tiers of teeth, as well as the number of teeth on each tier, may differ across embodiments.

Additionally, the number of teeth on different tiers may vary, the distribution of teeth on each tier may be different, and the size and shape of the teeth may also vary. Correspondingly, the number of tiers of grooves, the groove walls, and the number of cross-channels on each groove wall may vary across different embodiments. The number of cross-channels on different groove walls may differ, their distribution on each groove wall tier may vary, and the size and shape of the cross-channels may also vary. Further details and variations can be found in “Tube Connection and its Mechanism” (U.S. Pat. No. 18/596,675), filed on Mar. 6, 2024. It is worth noting that, in this embodiment, the tiered outer teeth are positioned on the blower nozzle base, while the tiered internal annular grooves are located on the rotatable elbow. However, in other embodiments of the present invention, this arrangement can be reversed, provided that the tiered outer teeth and the tiered internal annular grooves are configured such that one is on the blower nozzle base and the other is on the rotatable elbow.

It is also worth noting that, in the embodiment of the blower nozzle 100 shown in FIGS. 5-11, the locking mechanism of the rotatable connection achieves locking and unlocking by restricting rotational movement, thereby preventing the alignment of the teeth with the cross-channels. In alternative embodiments, the locking mechanism may function by blocking the cross-channels, which prevents the tiered outer teeth from passing through and disengaging the connection. Sections [0049] to [0054] provide details of an alternative locking mechanism.

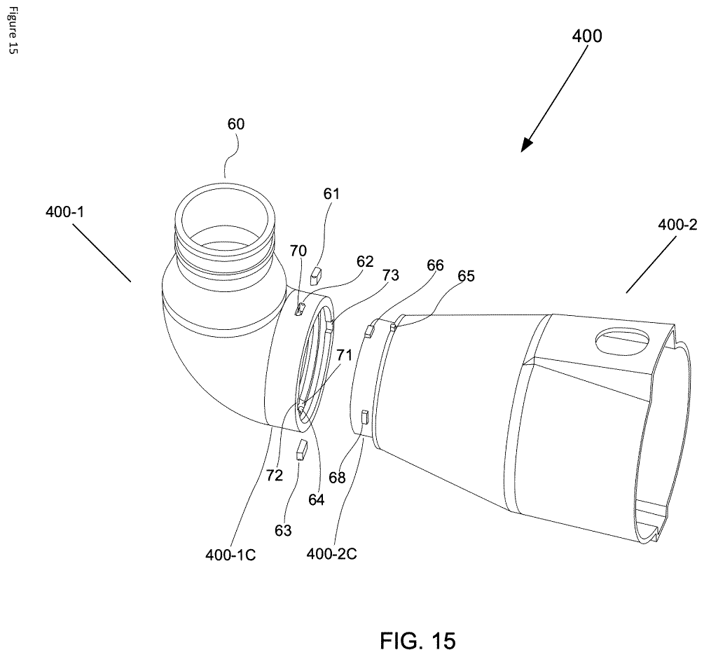

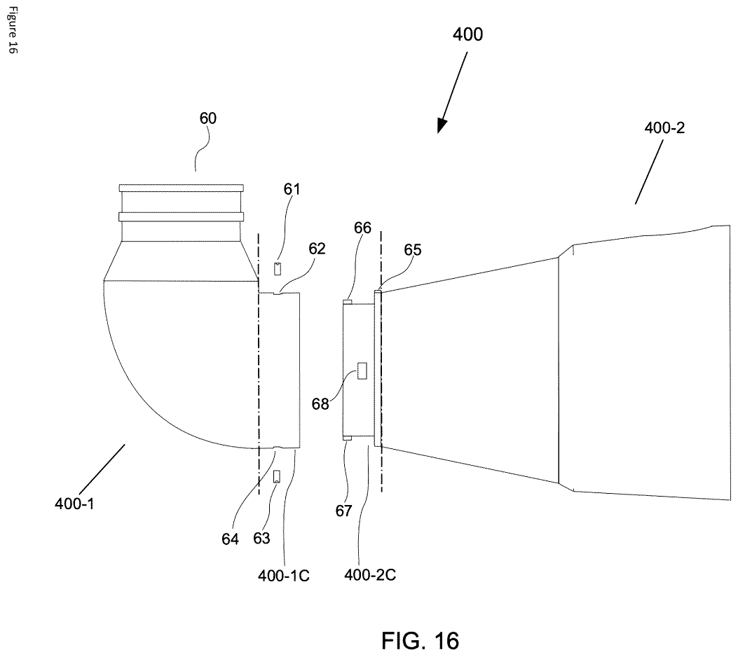

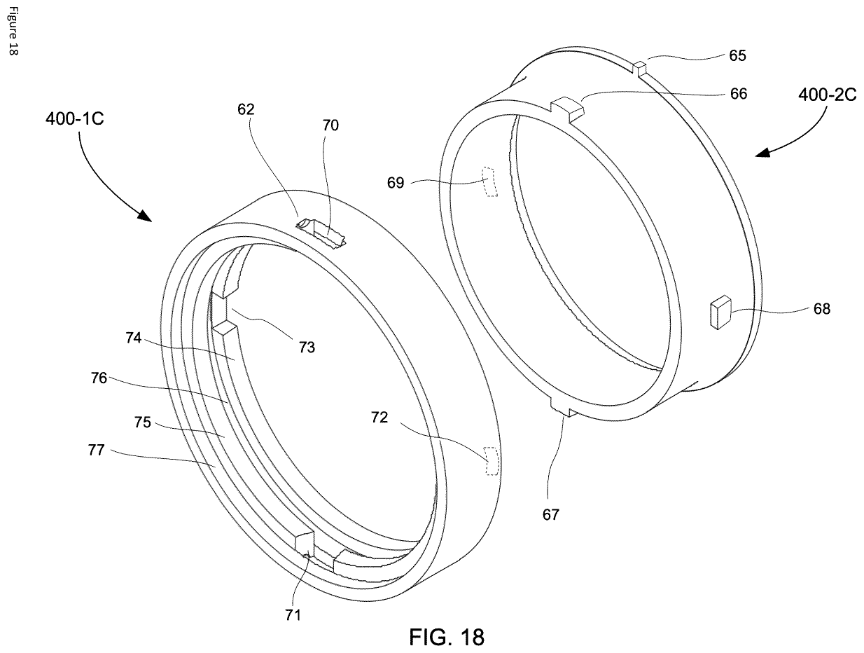

Referring to another embodiment shown in FIGS. 15-20, the blower nozzle 400 features a rotatable connection, with a male connector 400-2C having tiered outer teeth 66-69 and a female connector 400-1C with corresponding tiered internal annular grooves 76-77. These grooves 76-77 accommodate the teeth 66-69, allowing for movement within the grooves. Each groove, 76 or 77, has a groove wall (74 or 75) that includes two cross-channels (72-73 for groove 74 and 70-71 for groove 75), which enable the teeth 66-69 to pass through and transition into adjacent grooves. By rotating the connectors coaxially to either align or misalign the teeth 66-69 with the cross-channels 70-73, and applying axial movement (pushing or pulling), the connectors 400-1C and 400-2C can engage or disengage an interconnection.

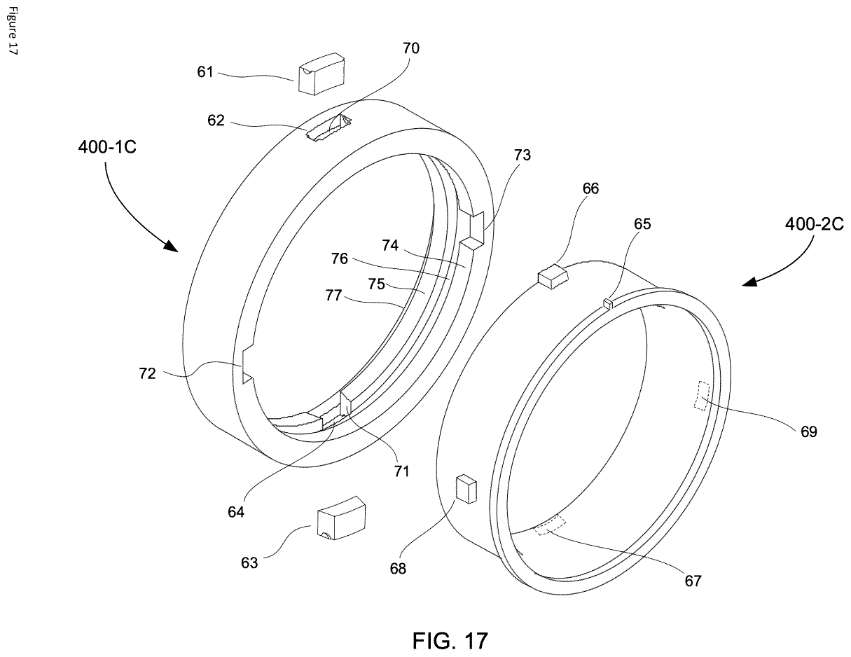

In further detail, referring to FIGS. 17, 18, and 19, the male connector 400-2C features two tiers of outer teeth 66-69. In this embodiment of the present invention, all teeth 66-69 are identical. Each tier includes two teeth positioned on opposite sides, dividing the circumference into equal halves. Teeth 66 and 67 belong to one tier, while teeth 68 and 69 belong to the other tier. The alignment of these teeth is such that the connecting line of each pair is perpendicular to the connecting line of the adjacent pair. Specifically, the line connecting the centers of teeth 66 and 67 is perpendicular to the line connecting the centers of teeth 68 and 69. The female connector 400-1C includes two tiers of annular grooves 76 and 77, designed to accommodate the movements of the teeth 66-69 of the male connector 400-2C. The two tiers of grooves 76 and 77 are defined by two corresponding groove walls 74 and 75. Each groove wall includes a pair of cross-channels to allow the passage of the teeth of the male connector 400-2C, facilitating their transition into adjacent grooves. Specifically, cross-channels 72 and 73 are part of groove wall 74, and cross-channels 70 and 71 are part of groove wall 75. The alignment of these cross-channels is such that the connecting line of each pair is perpendicular to that of the adjacent pair. Specifically, the line connecting the centers of cross-channels 72 and 73 is perpendicular to the line connecting the centers of cross-channels 70 and 71.

The female connector 400-1C also includes a pair of locking latches 61 and 63. The shapes and dimensions of the locking latches 61 and 63 correspond to those of the latch locking holes 62 and 64, as well as the cross-channels 70 and 71. The locking latches 61 and 63 can be inserted into the latch locking holes 62 and 64, thereby blocking the cross-channels 70 and 71, but not blocking the internal annular groove 77. This prevents the disengagement of the connectors (400-1C and 400-2C) by stopping the teeth 66-67 from passing through the cross-channels 70-71, while allowing the teeth to move freely within the internal annular grooves.

It is worth noting that if either of the locking latches 61 or 63 and their corresponding latch locking holes are configured to be thicker than the groove wall 75, causing the latch to block any of the internal annular grooves, it thereby limits the rotational movement of the rotatable connection. In this case, the locking mechanism functions as a new embodiment of the present invention that prevents disengagement by blocking the alignment of the tiered outer teeth with the cross-channels inside the annular grooves, ensuring that the teeth cannot move through the cross-channels and that the connection remains secure during operation, while allowing limited rotational movement of the rotatable connection.

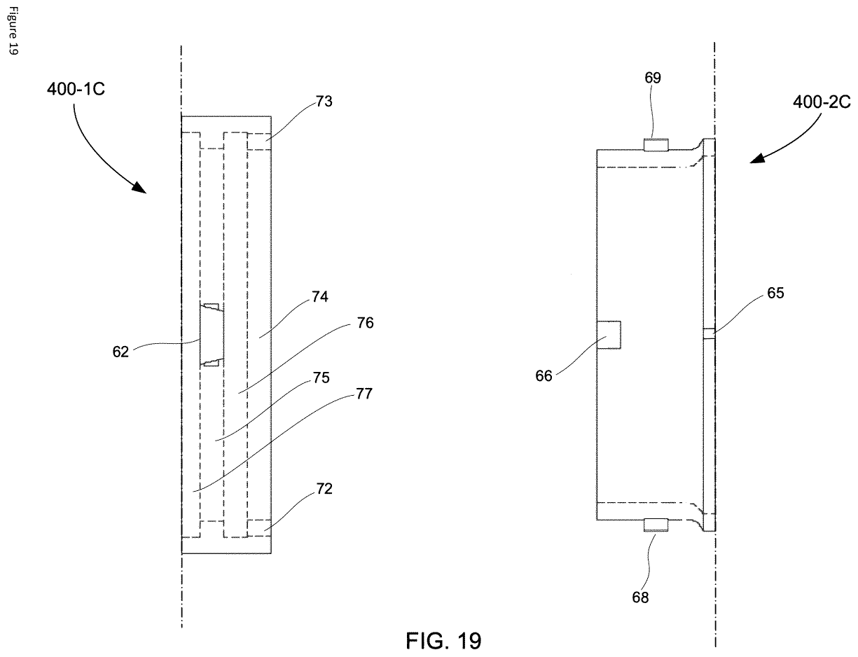

In more detail, referring to FIGS. 17 and 19, the top view shows that the locking latches 61 and 63, latch holes 62 and 64, and cross-channels 70 and 71 have trapezoidal shapes with the short side facing the male connector 400-2C. To assemble the blower nozzle 400, when teeth 66 and 67 are aligned with cross-channels 72 and 73, pushing the male connector 400-2C and the female connector 400-1C toward each other allows teeth 66 and 67 to pass through the groove wall 74 via the cross-channels 72 and 73, entering the annular groove 76. By then twisting the male and female connectors to perform a relative coaxial rotation of 90 degrees, in either a clockwise or counterclockwise direction, locator 65 aligns with either latch locking hole 62 or 64, and teeth 66 and 67 align with cross-channels 70 and 71. At the same time, teeth 68 and 69 align with cross-channels 72 and 73. Pushing the connectors together again in this position allows teeth 66 and 67 to move through groove wall 75 via cross-channels 70 and 71, thereby entering annular groove 77. Concurrently, teeth 68 and 69 move through groove wall 74 via cross-channels 72 and 73, entering annular groove 76.

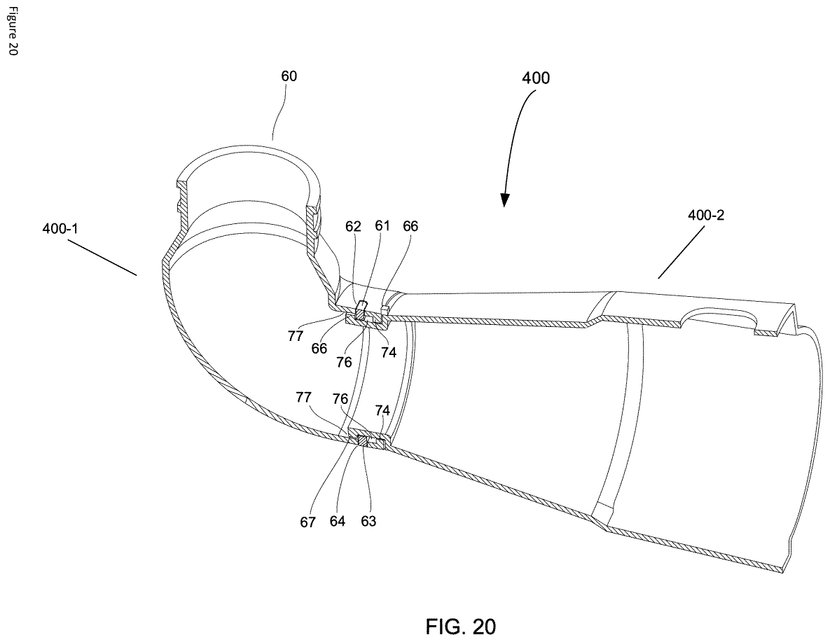

In this state, all tiers of teeth 66-69 are engaged with their respective grooves: groove 77 accommodates teeth 66 and 67, and groove 76 accommodates teeth 68 and 69. Finally, inserting the locking latches 61 and 63 into the locking latch holes 62 and 64 blocks the cross-channels 70 and 71, thereby completing the assembly of the blower nozzle 400 with rotatable elbow. FIG. 20 illustrates this fully engaged and secured state of the rotatable connection of the blower nozzle 400 with rotatable elbow 400-1.

While various details of the second exemplary embodiment of the present invention have been described in sections [0049] to [0054], it should be understood that other embodiments featuring a locking mechanism that blocks cross-channels are possible. The specific details may vary depending on the application. For example, the number of tiers of teeth, as well as the number of teeth on each tier, may vary in different embodiments. Additionally, the numbers of teeth on each tier may differ, the distribution of teeth on each tier may vary, and the size and shape of the teeth may also vary. Correspondingly, the number of tiers of grooves and groove walls, as well as the number of cross-channels on each groove wall, may also vary across different embodiments. The number of cross-channels on different groove walls, their distribution on each tier, and the size and shape of the cross-channels may also vary. Similarly, the number of locking latches and latch holes, as well as the cross-section shape of the locking latches and latch holes, may vary.

The disclosed embodiments are illustrative, not restrictive. While specific configurations of the exemplary portable gutter and downspout cleaning device with rotatable elbow have been described, it is understood that the present invention can be applied to a wide variety of portable gutter and downspout cleaning application. There are many alternative ways of implementing the invention.

1. A portable gutter and downspout cleaning device configured for use with a leaf blower, comprising: a blower nozzle having a rotatable elbow, wherein the rotatable elbow is configured to adjust the direction of the air; and a flat plastic tubing connected to the rotatable elbow, the flat plastic tubing being flexible, lightweight, and having a smooth internal surface; wherein the airflow generated by the leaf blower causes the flat plastic tubing to expand and maintain an extended shape, thereby creating an airtight contact with the interior of a downspout, facilitating the removal of debris from the downspout through the airflow directed via the tubing, and wherein the connection between the flat plastic tubing and the rotatable elbow is secured using fastening components, allowing the length of the flat plastic tubing to be customized based on different gutter heights and accessibility for cleaning gutters and downspouts from ground level.

2. The portable gutter and downspout cleaning device of claim 1, further comprising: a gutter cleaning nozzle having an extension pole socket, the gutter cleaning nozzle configured to receive air from the flat plastic tubing and direct the air toward the gutter in the removal of debris; wherein the connection between the flat plastic tubing and the gutter cleaning nozzle is secured using fastening components, allowing the length of the tubing to be customized based on different gutter heights and accessibility, and wherein the gutter cleaning nozzle can be attached to an extension pole, providing the user the ability to adjust the cleaning nozzle position for cleaning overhead gutters from ground level.

3. A blower nozzle with a rotatable elbow, comprising: a blower nozzle base configured to connect to a blower for receiving airflow generated by the blower; a rotatable elbow connected to the blower nozzle base, wherein the rotatable connection between the blower nozzle base and the rotatable elbow is formed by tiered outer teeth and tiered internal annular grooves, with the tiered outer teeth positioned on one of the components, either the blower nozzle base or the rotatable elbow, and the corresponding tiered internal annular grooves positioned on the other component; wherein the tiered internal annular grooves include groove walls that hold the teeth and allow their movement within the grooves, each of the groove walls incorporating at least one cross-channel for the passage of the teeth; wherein engagement is achieved through relative coaxial rotation to align the tiered outer teeth with the cross-channels, accompanied by axial movement that allows the teeth to pass through the cross-channels and enter adjacent grooves, thereby establishing a connection; wherein, once engaged, the connection between the blower nozzle base and the rotatable elbow permits relative rotational movement while maintaining the connection; and wherein disengagement of the connection is achieved by rotating the rotatable elbow to realign the teeth with the cross-channels, allowing the teeth to pass back through the cross-channels and exit the grooves, thereby enabling disassembly through axial movement.

4. The blower nozzle of claim 3, wherein the rotatable connection between the blower nozzle base and the rotatable elbow includes a locking mechanism, the locking mechanism having corresponding elements on both the blower nozzle base and the rotatable elbow that make contact when the relative rotational movement reaches a defined range, thereby restricting the alignment of the tiered outer teeth with the cross-channels, such that the locking mechanism prevents the teeth from passing through the cross-channels to disengage the connection, while allowing limited rotational movement of the rotatable elbow within the defined range.

5. The blower nozzle of claim 3, wherein the rotatable connection between the blower nozzle base and the rotatable elbow further comprises a locking mechanism, wherein the locking mechanism comprises corresponding elements positioned on the component that features the internal annular grooves, groove walls, and cross-channels, wherein said elements block the cross-channels but do not block the grooves, thereby preventing the tiered outer teeth from passing through the cross-channels to disengage the connection, while allowing the teeth to move freely within the grooves and permitting rotational movement of the rotatable elbow.

6. The blower nozzle of claim 5, wherein the corresponding elements of the locking mechanism include at least one locking latch and one latch hole on the component featuring internal annular grooves, groove walls, and cross-channels, wherein the locking mechanism engages by inserting the locking latches into the latch holes, which blocks the cross-channels but does not block the grooves, thereby preventing the tiered outer teeth from passing through the cross-channels to disengage the connection, while allowing the teeth to move freely within the grooves and permitting rotational movement of the rotatable elbow.

7. The blower nozzle of claim 3, wherein the rotatable connection between the blower nozzle base and the rotatable elbow further comprises a locking mechanism, wherein the locking mechanism includes corresponding elements comprising at least one locking latch and one latch hole positioned on the component featuring internal annular grooves, groove walls, and cross-channels, wherein the locking mechanism engages by inserting the locking latch into the latch hole, thereby blocking both the cross-channels and the internal annular grooves, wherein the tiered outer teeth located within the blocked internal annular grooves act as corresponding elements of the locking mechanism on the other component of the blower nozzle, and wherein, during continued relative rotational movement between the blower nozzle base and the rotatable elbow, the tiered outer teeth moving within the blocked internal annular grooves eventually contact the locking latch, thereby restricting the alignment of the tiered outer teeth with the cross-channels, whereby the locking mechanism prevents the teeth from passing through the cross-channels to disengage the connection, while allowing limited rotational movement of the rotatable elbow within the defined range.

8. A portable gutter and downspout cleaning device configured for use with a leaf blower, comprising: a blower nozzle having a rotatable elbow, wherein the rotatable connection between the blower nozzle base and the rotatable elbow is formed by tiered outer teeth and tiered internal annular grooves; a flat plastic tubing connected to the rotatable elbow, the flat plastic tubing being flexible, lightweight, and having a smooth interior surface, wherein the airflow generated by the leaf blower causes the flat plastic tubing to expand and maintain an extended shape, thereby creating an airtight contact with the interior of a downspout, facilitating the removal of debris from the downspout through airflow directed via the tubing; wherein the connection between the flat plastic tubing and the rotatable elbow is secured using fastening components, allowing the length of the flat plastic tubing to be customized by cutting based on different gutter heights and accessibility for cleaning gutters and downspouts from ground level; wherein the tiered outer teeth are positioned on one of the components of the blower nozzle, either the blower nozzle base or the rotatable elbow, and the corresponding tiered internal annular grooves are positioned on the other component of the blower nozzle; wherein the tiered internal annular grooves feature groove walls that accommodate the teeth and allow their movement within the grooves, each of the groove walls incorporating at least one cross-channel for the passage of the teeth; wherein engagement of the rotatable connection is achieved by relative coaxial rotation to align the tiered outer teeth with the cross-channels, accompanied by axial movement that allows the teeth to pass through the cross-channels and enter adjacent grooves, thereby establishing the connection, wherein, once engaged, the connection between the blower nozzle base and the rotatable elbow permits relative rotational movement while maintaining the connection; wherein disengagement of the rotatable connection is achieved by rotating the rotatable elbow to realign the teeth with the cross-channels, allowing the teeth to pass back through the cross-channels and exit the grooves, thereby enabling disassembly through axial movement.

9. The portable gutter and downspout cleaning device of claim 8, further comprising: a gutter cleaning nozzle having an extension pole socket, the gutter cleaning nozzle being configured to receive air from the flat plastic tubing and direct air toward the gutter to facilitate the removal of debris, wherein the connection between the flat plastic tubing and the air inlet of the gutter cleaning nozzle is secured using fastening components, allowing the length of the flat plastic tubing to be customized by cutting based on different gutter heights and accessibility, and wherein the gutter cleaning nozzle is attachable to an extension pole, enabling the user to adjust the position of the cleaning nozzle for cleaning overhead gutters from ground level.

10. The portable gutter and downspout cleaning device of claim 8, wherein the rotatable connection between the blower nozzle base and the rotatable elbow further comprises a locking mechanism, the locking mechanism including corresponding elements on both the blower nozzle base and the rotatable elbow that contact each other when the relative rotational movement reaches a defined range, thereby restricting the alignment of the tiered outer teeth with the cross-channels, wherein the locking mechanism prevents the teeth from passing through the cross-channels to disengage the connection, while allowing limited rotational movement of the rotatable elbow within the defined range.

11. The portable gutter and downspout cleaning device of claim 8, wherein the rotatable connection between the blower nozzle base and the rotatable elbow further comprises a locking mechanism, wherein the locking mechanism includes corresponding elements positioned on the component featuring the internal annular grooves, groove walls, and cross-channels, wherein the said elements block the cross-channels but not the grooves, thereby preventing the tiered outer teeth from passing through the cross-channels to disengage the connection, while allowing the teeth to move freely within the grooves and permitting rotational movement of the rotatable elbow.

12. The portable gutter and downspout cleaning device of claim 8, wherein the rotatable connection between the blower nozzle base and the rotatable elbow further comprises a locking mechanism, wherein the locking mechanism includes corresponding elements comprising at least one locking latch and one latch hole positioned on the component featuring internal annular grooves, groove walls, and cross-channels, wherein the locking mechanism engages by inserting the locking latch into the latch hole, thereby blocking both the cross-channels and the internal annular grooves; wherein the tiered outer teeth located inside the blocked internal annular grooves serve as corresponding elements of the locking mechanism on the other component of the blower nozzle; and wherein, during continued relative rotational movement between the blower nozzle base and the rotatable elbow, the tiered outer teeth moving inside the blocked internal annular grooves eventually contact and are stopped by the locking latch, thereby restricting the alignment of the tiered outer teeth with the cross-channels, whereby the locking mechanism prevents the teeth from passing through the cross-channels to disengage the connection while allowing limited rotational movement of the rotatable elbow within the defined range.

13. The portable gutter and downspout cleaning device of claim 10, further comprising a gutter cleaning nozzle with an extension pole socket, wherein the gutter cleaning nozzle is configured to receive air from the flat plastic tubing and direct the air toward the gutter to facilitate debris removal, wherein the connection between the flat plastic tubing and the air inlet of the gutter cleaning nozzle is secured using fastening components, thereby allowing the length of the flat plastic tubing to be customized by cutting based on different gutter heights and accessibility, and wherein the gutter cleaning nozzle is attachable to an extension pole, enabling the user to adjust the position of the cleaning nozzle for cleaning overhead gutters from ground level.

14. The portable gutter and downspout cleaning device of claim 11, further comprising a gutter cleaning nozzle with an extension pole socket, wherein the gutter cleaning nozzle is configured to receive air from the flat plastic tubing and direct the air toward the gutter to facilitate debris removal, wherein the connection between the flat plastic tubing and the air inlet of the gutter cleaning nozzle is secured using fastening components, thereby allowing the length of the flat plastic tubing to be customized by cutting based on different gutter heights and accessibility, and wherein the gutter cleaning nozzle is attachable to an extension pole, enabling the user to adjust the position of the cleaning nozzle for cleaning overhead gutters from ground level.

15. The portable gutter and downspout cleaning device of claim 12, further comprising a gutter cleaning nozzle with an extension pole socket, wherein the gutter cleaning nozzle is configured to receive air from the flat plastic tubing and direct it toward the gutter to facilitate debris removal, wherein the connection between the flat plastic tubing and the air inlet of the gutter cleaning nozzle is secured using fastening components, thereby allowing the length of the flat plastic tubing to be customized by cutting based on different gutter heights and accessibility, and wherein the gutter cleaning nozzle is attachable to an extension pole, enabling the user to adjust the position of the cleaning nozzle for cleaning overhead gutters from ground level.
